(19) United States
(12) Patent Application Publication
(10) Pub. No.: US 2019/0299220 A1
(43) Pub. Date: Oct. 3, 2019

(54) SORTING SYSTEM

(71) Applicant: Doppstadt Familienholding GmbH, Velbert (DE)

(72) Inventor: Ferdinand DOPPSTADT, Velbert (DE)

(73) Assignee: Doppstadt Familienholding GmbH, Velbert (DE)

(21) Appl. No.: 16/304,344

(22) PCT Filed: May 26, 2017
(86) PCT No.: PCT/EP2017/062808

§ 371 Date: Nov. 26, 2018

(30) Foreign Application Priority Data
May 27, 2016 (DE) 20 2016 003 285.3

(51) Int. Cl. B03B 9/06; B09B 5/00; B07C 5/34; B07C 5/342; B07C 5/344; B07B 4/08

(52) U.S. Cl. CPC B03B 9/06; B09B 5/00; B07C 5/3416; B07C 2501/0054; B07C 5/344; B07B 4/08; B07C 5/342

(57) ABSTRACT

The invention relates to a sorting system (I) for separating fractions of mixed waste, the system consisting of at least one support unit (1), at least one receiving unit (2), at least one sorting unit (3) at least one ejection unit (4), and at least one drive unit (5). The invention is characterized in that the sorting unit (3) comprises at least one interchangeable and expandable identification sub-assembly (31) for identifying the component parts of the fraction of mixed waste.

### BACKGROUND OF THE INVENTION

The invention relates to a sorting system for separating fractions of mixed waste, the system consisting of at least one support unit, at least one receiving unit, at least one sorting unit, at least one ejection unit, and at least one drive unit.

Sorting systems of this kind are known as interlinked sorting systems carrying out the separation of fractions of mixed waste as stationary and permanently installed process lines. Generally, the separation of the fractions of mixed waste is carried out by selectively operating sensors and trigger devices coupled thereon. Systems of this kind focus on sorting certain fractions of mixed waste. Regularly they can only perform a separation of the fraction of mixed waste into material component parts that have been pre-determined, that is they have already been known when the system has been planned.

However, the operators of such systems and also the current legislation request a permanently improving separation into fractions of materials from mixed waste that the current sorting systems cannot perform because of the above described lack of flexibility. Additionally, mixed fractions become permanently smaller so that the pressure on the economy of the known process lines increases considerably. Because of this situation the operators would be forced to acquire further sorting systems complying with respective requirements of fractions of mixed waste. Of course, this is very expensive and thus not economic for the often medium-sized operators.

### PRIOR ART

In the state of the art solutions of this kind are known, as already described. For example, the Austrian patent specification AT 502 172 A4 describes such a solution. However, the solution described there is limited to a system for the selective treatment of waste material from electric and/or electronic apparatus. Preferably it refers to old apparatus. Other separation tasks that could be solved by means of such a solution are not described. Accordingly, that Austrian specification also shows the above described disadvantages of the state of the art.

From the US 2014/0077007 it is known to separate compostable material from non-compostable material. However, the solution is characterized in that different separation tasks have to be executed by different device components. Of course, this increases the efforts for the system technology considerably. Therefore here also the disadvantages of the state of the art as described in the beginning are present here.

### SUMMARY OF THE INVENTION

Therefore it is the problem of the invention to provide a sorting system that does not have anymore the disadvantages known from the state of the art. The sorting system should be adaptable to the changing requirements, and be able to perform a permanently increasing separation into material fractions from the mixed waste.

The problem of the invention is solved by a sorting system for separating fractions of mixed waste, consisting of at least one support unit, at least one receiving unit, at least one sorting unit, at least one ejection unit, and at least one drive unit, that is characterized in that the sorting unit comprises at least one interchangeable and expandable identification sub-assembly for identifying the component parts of the fraction of mixed waste. The solution according to the invention provides a process solution for this process task that clearly increases the degree of use of the identification and/or ejection systems, and in particular the economic efficiency of these systems. Now it is possible to react accordingly to the respective fraction of mixed waste by adapting the identification sub-assembly by replacing single functional components or expanding with other functional components. It is an advantage when the functional components are provided in standardized units so that only a replacement of components or adding of suitable components is necessary. The solution according to the invention removes all disadvantages of the state of the art as described in the beginning.

According to a first modification the invention provides that the identification sub-assembly has at least one replaceable functional component for identifying at least one of the parts or even different parts of the fraction of mixed waste. Thus it is already here possible to identify and separate different materials from the fraction of mixed waste by means of a single system.

Of course, it is an advantage according to another modification of the solution according to the invention that the identifying sub-assembly has at least two, preferably more than two, replaceable or expandable functional components for identifying the different parts of the fraction of mixed waste. The advantages are obvious as the system can be employed essentially more universally. It can be employed simultaneously, that is without any retrofitting, for very different components to be separated.

A particularly advantageous modification of the solution according to the invention is the fact that it has been suggested to assemble or integrate the construction of the functional components into at least one detection unit. This will lead to another increase of the general efficiency of the entire system. The effort for a necessary retrofitting is further reduced. If required, only the detection unit is replaced.

According to another aspect of the invention it is provided that the identification sub-assembly or the detection unit comprises at least one detector, at least one sensor, at least one probe, at least one irradiation device, at least one screening device, at least one electronic component for identifying material and/or substances, or at least one system for identifying gas. It is an advantage when several of the before cited elements are assembled in the detection unit. However, it is not necessary according to the invention to provide each time all of the described elements in one detection unit. It is rather possible to act variably when assembling the unit, depending on the mixed fractions to be separated. As the detection unit altogether is also provided as a replaceable element, the detection unit according to the invention can be assembled and installed according to the respective separation task.

It is a particular advantage according to a preferred modification of the invention when all functional components or assemblies as elements of the detection unit can be connected or disconnected singularly, double, multiple or in blocks. This makes the apparatus generally usable that several provided physical detection methods can now be carried out by means of a single detection component by activating or deactivating different functions by “switching” or “selecting”. This makes retrofitting the system or a replacement of (larger) sensor components or detecting components redundant. By means of such a solution the material can be processed in several cycles, for example, by setting the device to only one target material and then separating it. Then the device is set to the next target material, and the next material is sorted out. By means of a very simple device this process may be repeated as many times as there are parts in the fraction of mixed waste material. This does not only contribute to a reduction of the system in process technical view but also in view of the effort for the device.

A sorting system as described before is characterized according to a development of the invention in that the sorting system has a frame at or on which all system parts required for sorting are or can be arranged. This design allows, in addition to the increase of flexibility, also moving the system within a recycling center and/or to another site. By means of suitable load handling attachment and, if necessary, transport means, moving can be carried out easily. It is another advantage here when the frame is configured such that it is or can be arranged for example on a transport means, such as, for example, a low-bed truck. This design will be discussed in detail further on.

A modification of the solution according to the invention is characterized in that the frame is arranged replaceably at the sorting system, and/or at or on the transport means. Replacing the frame allows, when the task for sorting changes, to replace the frame and to install another frame adapted to the new sorting task. This makes for an even more universal use of the system altogether and an adaptability to very different sorting tasks without any problems.

The sorting system according to the invention is characterized in that the sorting unit comprises a sorting belt. The parts of the mixed fraction arriving through the receiving unit are spread on the sorting belt so that they can be detected without any problems by the identification systems of the sorting unit and subsequently separated.

It has been found according to the invention to be an advantage when the sorting belt can be driven with variable speed. Thus certain compositions of the fraction of mixed waste can be reacted on by increasing the speed of the belt, for example when there are less different parts on the sorting belt, or by reducing the speed when there are many different parts on the belt.

Another aspect of the solution according to the invention is characterized in that the sorting unit has at least one color recognition system, and/or at least one infrared and/or near-infrared recognition system, and/or at least one X-ray system. The above-mentioned systems can detect the single parts of the fraction of mixed waste very clearly. The information gained here is then recorded electronically, and advantageously be transmitted to the ejection unit. Of course, it can also be processed directly by the sorting unit. The invention is not restricted to the above-mentioned modification.

The sorting system according to the invention is, according to a development, characterized in that the sorting unit recognizes the single parts of the fractions of mixed waste, records this information, and then transmits it to a control or directly to the ejection unit that selects and ejects or delivers the detected parts depending on the transmitted information.

Another modification of the invention provides that the sorting unit has at least one separating device for separating magnetic parts of the fraction of mixed waste. Thus magnetic parts can be separated in a simple way from non-magnetic parts of the fraction of mixed waste. The magnetically detected parts then are ejected separately out of the sorting system so that they can be conveyed to further processing or collected for delivery to a recycling plant.

It has turned out to be an advantage when the sorting system according to the invention is equipped with a separating device for separating magnetic parts as an overhead belt. Of course, the solution of the construction may differ, so that the invention is not restricted to this modification.

Furthermore it has been found according to the invention to be an advantage when the receiving unit is arranged upstream the sorting unit seen in operating direction. Thus constructive efforts for transporting the received waste to the sorting unit can be reduced.

Another modification of the invention is characterized in that the receiving unit has a receiving funnel. The waste is put in this receiving funnel and mixed and spread there. The effect should be an even flow of mixed waste into the sorting unit.

In order to guarantee a continuous supply of waste to the sorting unit, the receiving funnel is provided with essentially vertical sidewalls, at least in the bottom area in operating position. This provides always a sufficient supply of fractions of mixed waste to be processed in the system.

According to the invention it has turned out to be a considerable advantage when in or at the receiving funnel at least one dispensing or distributing device is provided. By means of this dispensing or distributing device the introduced waste can be spread evenly to the entire working width of the device.

An embodiment of the invention provides that as dispensing or distributing device at least one spreading auger and/or shaft is provided. However, this modification may not be seen as restricting as it is, of course, also possible to provide other spreading devices.

Accordingly, a modification of the invention suggests that a spreading auger is provided as distributing device, the spreading auger being formed symmetrically and provided with inversely extending screw pitches. This inversely extending screw pitch allows a particularly even spreading of the material to be sorted.

When the distributing device is carried out as spreading shaft, it has turned out according to the invention to be particularly advantageous when the spreading shaft has a core diameter of preferably 400 to 600 mm, and spread rails arranged at the diameter with a total exterior diameter of 500 to 900 mm. These dimensions are nearly perfect, however, they should not be understood as a restriction for the entire invention.

It is another advantage when the receiving unit of the sorting system according to the invention has at least in the hand-over zone to the sorting unit essentially the same working width as the downstream sorting belt. The advantage of this modification has already been discussed. Furthermore it has to be remarked that this may reduce the entire length of the whole system. Furthermore, thus the maximum working width of the construction becomes available.

It is another aspect of the sorting system according to the invention that the ejection unit is provided in the back part of the sorting unit, seen in operating direction. This construction serves for saving unnecessary transport paths, and for conveying parts supplied by the sorting unit on the shortest way to the ejection unit.

For removing the detected and selected parts from the sorting system the ejection unit has at least one side conveyor according to the invention. However, it is also possible to provide two or more of such side conveyors so that simultaneously several fractions of not anymore mixed material can be conveyed to the respective storage containers or storage sites. Of course it is also possible to convey the material fractions immediately from the sorting system to a transport vehicle for transport to further processing via the sides of the conveyor belts.

For an even more efficient selecting the ejection unit has at least one eddy current cylinder for separating non-iron metals. Thus non-iron metals can be separated very easily from other material, and simultaneously different fractions of non-iron metals can be formed.

A modification of the invention provides that the ejection unit has one or more blowing nozzles for separating detected parts of the fraction of mixed waste. The blowing nozzles get the necessary information from the control or directly from the sorting unit, so that the pressure can be controlled accordingly in order to expose different parts to different pressure so that they can be ejected in different distances.

Another advantageous modification according to the invention suggests that the ejection unit has at least one separating metal plate for separating the parts of the fraction of mixed waste accelerated differently by the blowing nozzles. The result will be very cleanly separated material fractions.

Furthermore it has been found according to the invention to be convenient when the ejection unit is combined or coupled with another removal device arranged preferably on the side for a spillover or the not detected parts of the fraction of mixed waste. Thus even the non-detected parts can be removed or returned to the receiving unit separately.

The sorting system according to the invention has also a drive unit, the drive unit being designed as PowerBox according to the invention that provides all necessary media and support energy. This creates another system component that can be employed universally and is in particular interchangeable.

As medium the drive unit provides at least the hydraulic pressure oil supply, electric energy, compressed air and drive energy for driving the movable components of the sorting system as well as the control of the electric, hydraulic, pneumatic as well as data and security installations of the sorting system. However, it is possible to provide the sorting system according to the invention with other media, if required. If necessary the required modules or parts of the PowerBox have to be added to the drive unit.

As already mentioned, the PowerBox is designed as replaceable module. Thus, for example differently equipped PowerBoxes can be supplied for an easy exchange, if necessary.

The sorting system according to the invention is characterized by either an electric motor, a combustion engine or a hydraulic motor as drive motor. The invention is not limited to a certain drive.

It is also possible that the combustion engine is provided as primary energy supply. Thus for example it can produce the necessary electric energy for providing other process units. Of course, it can also drive the suitable pressure aggregates in order to provide the necessary media such as hydraulic or pneumatic media.

For the entire sorting system to be universally employable the single modules of the sorting system are equipped with a standardized coupling system for the supply of media. Without any problems other modules can be added or certain modules be replaced, if necessary.

Another aspect of the solution according to the invention is characterized in that the entire system is arranged on a vehicle fit for the road. This allows an easy travel to different sorting sites while using the public road system. This allows an operator to carry out different sorting tasks at different sites. Of course it is also possible for several operators to share one system. By means of coordinating dates the system can be used very efficiently altogether so that the expenses are further reduced.

In another modification the invention suggests that the system is provided with skids or support wheels to allow moving within the site of a larger processing plant. Of course, this modification is also meant for those cases where moving is supposed to be carried out with special vehicles, such as for example low-bed trucks.

### DESCRIPTION OF THE DRAWINGS

In the following the invention will be described by means of an example. It is pointed out that the presented embodiment is not to be understood as a restriction of the invention. On the contrary, other modifications are comprised by the invention.

In the figures:

FIG. 1 is a three-dimensional representation of the sorting system according to the invention,

FIG. 2 is a side view of the sorting system according to the invention with a separation device for separating magnetic parts.

FIG. 3 is a top view of the embodiment according to FIG. 2.

In the following the three figures will be described as a complex, as in all figures identical features are referred to by identical reference numbers.

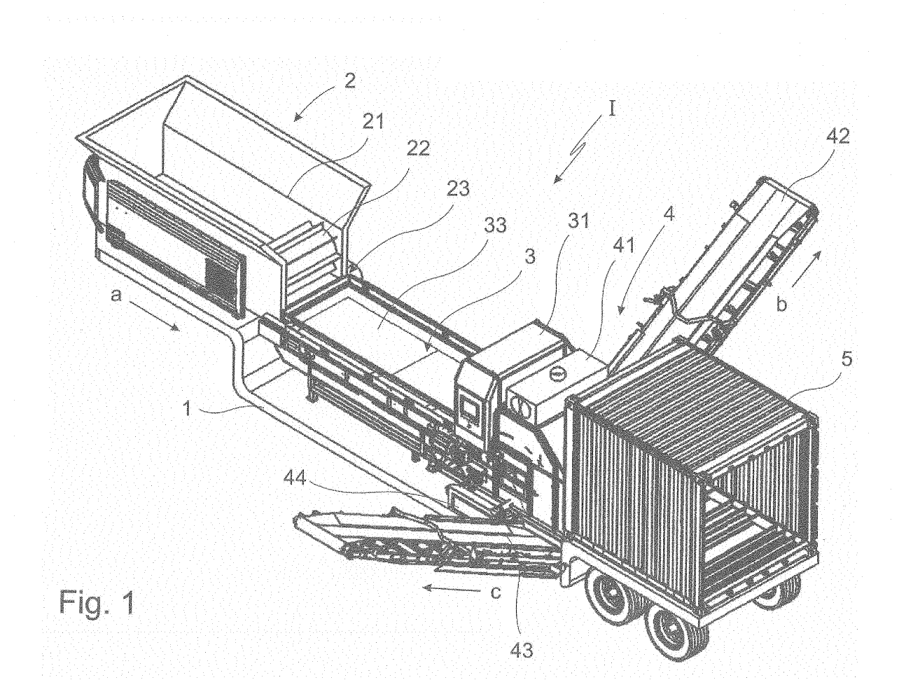

The sorting system I is schematically designated by an arrow. The entire system is arranged on the support unit 1. In the three-dimensional representation of FIG. 1 the receiving unit 2 is also designated by an arrow on the left hand side. The support unit 1 is in the embodiment of the representation designed as a frame. According to the invention, of course, other modifications of the embodiment of the support unit are comprised. However, the shown embodiment is sufficient for understanding. The receiving unit 2 is formed by a receiving funnel 21 that extends angularly outward to the top, while in the bottom area it has essentially vertical sidewalls. In the receiving funnel 21 a dispensing or distributing device 22 is provided. In the representation of the figure this dispensing or distributing device 22 is configured as a spreading shaft with spreading rails arranged at its diameter. At the transition zone from the receiving unit 2 to the sorting unit 3 a hand-over zone 23 is provided that has here the same working width as the subsequently arranged sorting belt 33.

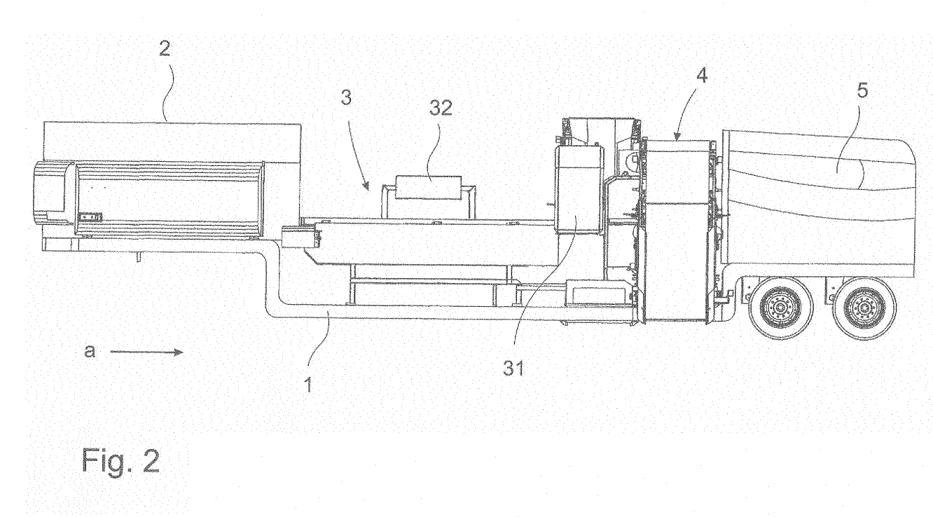

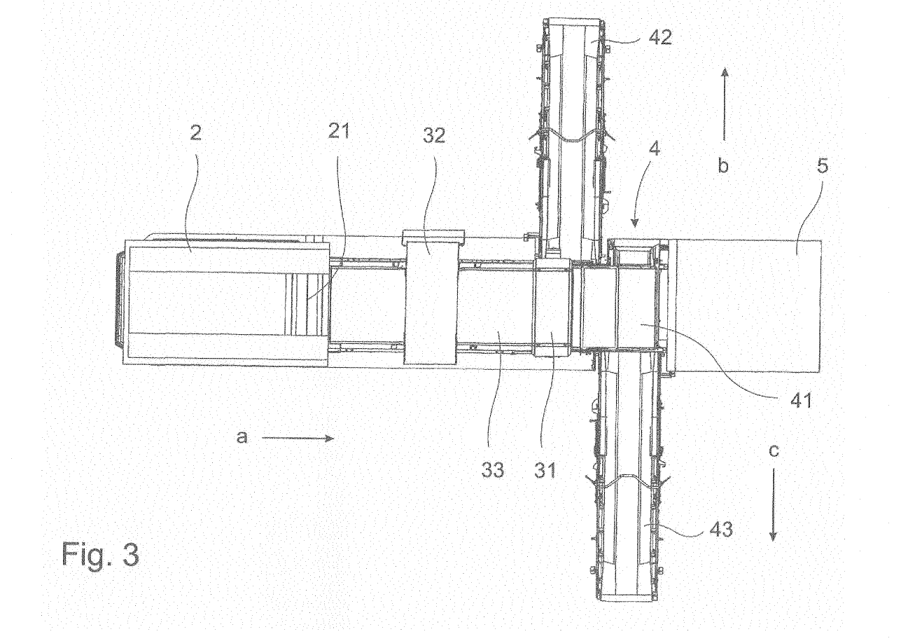

Accordingly, the sorting unit 3 follows the receiving unit 2. A sorting belt 33, that can be run with variable speed, belongs to the sorting unit 3. At the end of the sorting belt 33 the replaceable and/or expandable identification sub-assembly 31 is arranged. This identification sub-assembly 31 is configured here as a housing or switch cabinet. The identification sub-assembly 31 comprises functional modules provided in the interior of the housing or switch cabinet for identifying at least one of the parts or different parts of the fraction of mixed waste. These may also be the before described detection units that contain several functional components. Thus inside the switch cabinet for example a color detection system, an infrared and/or infrared recognition system or at least an X-ray system as functional components, assembled as a detection unit may be arranged. These components can be arranged separately or combined in the identification sub-assembly. The single systems are formed generally by sensors and/or radiators that can transfer the data collected via a control to the ejection unit 4. In FIGS. 2 and 3 a separating device 32 is arranged above the sorting belt 33. The separating device 32 serves for separating magnetic parts of the fractions of mixed waste. Removal is carried out in a suitable way, for example via a suitable conveyor. In the shown embodiment the separating device 32 is designed as overhead belt.

The ejection unit 4 follows the sorting unit 3 in the direction of working a. The ejection unit 4 has a separating device for selecting the detected parts. It is arranged in a housing 41. One or more blowing nozzles for separating detected parts of the fraction of mixed waste may be provided in the housing 41. Also a separating metal plate is provided serving for separating the parts of the fraction of mixed waste accelerated differently by the blowing nozzles during falling or sinking down.

The ejection unit 4 may also have an eddy current cylinder for the separation of non-iron metals. This can be arranged in the housing. However, it may also join the housing 41. It can also take over the task of the back deflection roller for the sorting belt 33.

In the representation of the figures the side conveyors 42 and 43, provided rectangularly on both sides to the working direction a, also belong to the ejection unit 4. Arrows b and c designate the respective ejection directions of the selected or non-selected material.

Seen in the installation direction below the identification sub-assembly 31 and the housing 41 a spillover 44 is provided serving for removing non-selected parts. The side conveyor 43 in the shown embodiment serves for removing non-detected parts of the fraction of mixed waste. Via a not shown return these parts can be redelivered to the receiving unit 2. Seen in working direction a at the end of the device the drive unit 5 is provided that is designed as PowerBox. This PowerBox is configured as an interchangeable module and, for example, contains the drive motor, the energy supply aggregate, the aggregates for producing the required support energy, such as, for example, hydraulic pressure, air pressure, electric energy. In the PowerBox are also the necessary components of the data and security devices of the sorting system arranged. The module-like design of the drive unit 5 allows to operate very different sorting units with very different sorting tasks. In the case that the device is equipped with a combustion engine, this can also be arranged in the PowerBox. The combustion engine serves as primary energy supplier for producing all necessary energy.

In the figures the sorting system I is arranged on a support unit 1 that can be coupled to a low-bed truck.

The invention has been described by means of an example. However, the invention is not restricted to such example and is without prejudice for obtaining broader protection.

The sub-claims relate to further embodiments of the main claim.

1. A sorting system for separating fractions of mixed waste, consisting of at least one support unit, at least one receiving unit, at least one sorting unit, at least one ejection unit, and at least one drive unit, wherein the sorting unit comprises at least one interchangeable and expandable identification sub-assembly for identifying the component parts of the fraction of mixed waste.

2. The sorting system according to claim 1, wherein the identification sub-assembly has at least one interchangeable functional module for identifying at least one of the parts or different parts of the fraction of mixed waste.

3. The sorting system according to claim 1, wherein the identification sub-assembly contains at least two replaceable and expandable functional modules for identifying different parts of the fraction of mixed waste.

4. The sorting system according to claim 1, wherein the identification sub-assembly has at least two replaceable and expandable functional modules for identifying different parts of the fraction of mixed waste.

5. The sorting system according to claim 1, wherein the functional modules are integrated in the construction of at least one detection unit.

6. The sorting system according to claim 5, wherein the detection unit of the identification sub-assembly comprises at least one detector, at least one sensor, at least one probe, at least one irradiation device and/or screening device, at least one electronic component for detecting material and at least one gas detection system.

7. The sorting system according to claim 4, wherein at least one functional modules of the detection unit can be connected or disconnected singly, doubly or in blocks.

8. The sorting system according to claim 1, wherein the sorting unit has a frame as a support unit on which all system modules required for sorting are arranged.

9. The sorting system according to claim 8, wherein the frame as a support unit is arranged replaceably at the sorting system.

10. The sorting system according to claim 1, wherein the sorting unit comprises a sorting belt.

11. The sorting system according to claim 10, wherein the sorting belt can be driven at varying speed.

12. The sorting system according to claim 1, wherein the sorting unit has at least one color recognition system, at least one infrared recognition system, or at least one X-ray system.

13. The sorting system according to claim 1, wherein the sorting unit recognizes the individual parts of the fractions of mixed waste, records this information, and transmits it to a control or directly to the ejection unit that selects the recognized parts and removes them according to the transmitted information.

14. The sorting system according to claim 1, wherein the sorting unit has at least one separating device for separating magnetic parts of the fractions of mixed waste.

15. The sorting system according to claim 1, wherein a separating device for separating magnetic parts as an overhead belt is provided.

16. The sorting system according to claim 1, wherein the receiving unit is arranged upstream the sorting unit seen in a working direction.

17. The sorting system according to claim 1, wherein the receiving unit has a receiving funnel.

18. The sorting system according to claim 17, wherein the receiving funnel is designed at least in working position in the bottom area with essentially vertical side walls.

19. The sorting system according to claim 17, wherein at the receiving funnel at least one distributing device is provided.

20. The sorting system according to claim 19, wherein at least one spreading auger is provided in the distributing device.

21. The sorting system according to claim 20, wherein the spreading auger in the distributing device is designed symmetrically and provided with inversely extending screw pitches.

22. The sorting system according to claim 20, wherein a spreading shaft in the distributing device has a core diameter of 400 to 600 mm, and spreading rails are arranged at the diameter with a total exterior diameter of 500 to 900 mm.

23. The sorting system according to claim 1, wherein the receiving unit has at least one hand-over zone to the sorting unit where it has essentially the same working width as a subsequent sorting belt of the sorting unit.

24. The sorting system according to claim 1, wherein the ejection unit is arranged in the back area of the sorting system seen in a working direction.

25. The sorting system according to claim 1, wherein the ejection unit has at least one side conveyor for removing detected and selected parts.

26. The sorting system according to claim 1, wherein the ejection unit has at least one eddy current cylinder for separating non-iron metals.

27. The sorting system according to claim 1, wherein the ejection unit has at least one blowing nozzles for the separation of detected parts of the fraction of mixed waste.

28. The sorting system according to claim 27, wherein the ejection unit has at least one separating metal plate for separating the parts of the fraction of mixed waste accelerated differently by blowing nozzles.

29. The sorting system according to claim 1, wherein the ejection unit is combined with another removal device, arranged on the side, for a spillover of the not detected parts of the fraction of mixed waste.

30. The sorting system according to claim 1, wherein the drive unit is configured as a PowerBox providing all necessary media and support energy, including hydraulic pressure oil supply, electric power, compressed air, and drive energy for driving the movable parts of the sorting system, as well as the control of electric, hydraulic, pneumatic, and data and security devices of the sorting system.

31. The sorting system according to claim 30, wherein the PowerBox as drive unit is configured as a replaceable module.

32. The sorting system according to claim 30, wherein as a drive motor an electric motor, a combustion engine, or a hydraulic motor is provided, as a primary energy supply.

33. The sorting system according to claim 1, wherein the components of the sorting system are provided with a standardized coupling system for a media supply.

34. The sorting system according to claim 1, wherein the entire sorting system is arranged on a vehicle fit for the road, which can be moved.
